(19) United States
(12) Patent Application Publication
(10) Pub. No.: US 2015/0355529 A1
(43) Pub. Date: Dec. 10, 2015

(54) STROBOSCOPIC DEVICE AND IMAGE PICKUP DEVICE PROVIDED WITH SAME

(71) Applicant: PANASONIC INTELLECTUAL PROPERTY MANAGEMENT CO., LTD., Osaka-shi, Osaka (JP)

(72) Inventors: MASAKAZU YAMAGUCHI, Aichi (JP); TAKAHIRO IKEDA, Mie (JP); TAKAKI INOUE, Osaka (JP); YOSHIHIRO KANBATA, Niigata (JP)

(21) Appl. No.: 14/759,371

(22) PCT Filed: Dec. 26, 2013
(86) PCT No.: PCT/JP2013/007620

§ 371 Date: Jul. 6, 2015

(30) Foreign Application Priority Data
Jan. 11, 2013 (JP) 2013-003394

(51) Int. Cl. G03B 15/05; H01J 40/12

(52) U.S. Cl. CPC G03B 15/05; H01J 40/12

(57) ABSTRACT

A stroboscopic device includes a flash discharge tube having an anode and a cathode, and an auxiliary light emitter for emitting light toward cathode. The auxiliary light emitter includes a light-receiving element for measuring a light intensity of external light near the flash discharge tube, a comparator for comparing the light intensity of light received by the light-receiving element with a predetermined threshold immediately before or substantially simultaneously with the light-emission timing of the flash discharge tube, and a lighting section that is lit when the light intensity is lower than the predetermined threshold based on a result of comparison by the comparator. This achieves a stroboscopic device and image pickup device that can stably emit light from the flash discharge tube irrespective of the surrounding environment.

### TECHNICAL FIELD

The present invention relates to stroboscopic devices that emit light from a flash discharge tube and image pickup devices provided with the stroboscopic device. More particularly, the present invention relates to stroboscopic devices and image pickup devices that can easily emit light from the flash discharge tube even in a dark place.

### BACKGROUND ART

In general, a camera (image pickup device), such as a digital still camera, is provided with a built-in stroboscopic device for applying light with sufficient light quantity to a shooting target, or has a structure to attach a separate stroboscopic device.

The stroboscopic device emits light with sufficient light quantity by flashing a flash discharge tube to illuminate a shooting target. The flash discharge tube includes a pair of anode and cathode that is sealed via glass bead at both ends of a glass tube. Noble gas (xenon) is sealed in the glass tube. By applying voltage to the anode and cathode, the noble gas is ionized. This forms a discharge path between the anode and cathode, and the flash discharge tube emits light.

Light emission from the flash discharge tube is achieved by a circuit shown in FIG. 4.

A general circuit for emitting light from the flash discharge tube is described below with reference to FIG. 4. FIG. 4 is a circuit diagram illustrating an example of a circuit in the stroboscopic device.

As shown in FIG. 4, the circuit in the stroboscopic device includes trigger external electrode 2, electric storage element 3, and battery power source 4 that are connected in parallel. Trigger external electrode 2 is provided on an outer periphery of flash discharge tube 1. Electric storage element 3 is configured typically with a capacitor. Battery power source 4 supplies power to electric storage element 3.

The above circuit also includes boost chopper circuit 5, controller 6, trigger circuit 7, and switch circuit 8. Boost chopper circuit 5 increases voltage of battery power source 4. Controller 6 typically controls the operation of the entire device. Trigger circuit 7 applies voltage to trigger external electrode 2 at a timing of emitting light from flash discharge tube 1. Switch circuit 8 controls the light emission time of flash discharge tube 1 based on a light-emission quantity needed for shooting.

Flash discharge tube 1 includes anode 9 and cathode 10, and is disposed, for example, in a gutter-like reflector (not illustrated). In a state that voltage is applied between anode 9 and cathode 10, flash discharge tube 1 momentarily flashes when voltage is momentarily applied to trigger external electrode 2 from trigger circuit 7. Here, a flash light by light emission from flash discharge tube 1 is reflected on the reflector to momentarily illuminate a shooting target.

In general, to stably emit light from flash discharge tube 1, the voltage between anode 9 and cathode 10 (lighting voltage) is preferably low.

However, the lighting voltage applied to flash discharge tube 1 tends to become high typically in a dark place. This is because the inside of flash discharge tube 1 is electrically balanced when flash discharge tube 1 is not lit, and thus there are no free electrons. More specifically, none or only a small quantity of light in a dark place results in less generation of free electrons radiating in flash discharge tube 1. Accordingly, a high lighting voltage is needed on flashing, so as to emit free electrons from the cathode. For this purpose, a voltage doubler circuit for applying a high voltage to flash discharge tube 1 is generally used for stably emitting light from flash discharge tube 1 also in a dark place.

To stably emit light from the flash discharge tube, a device as configured below is proposed.

One known example is a portable communication device for reducing voltage applied to the anode and cathode by emitting an ultraviolet light to noble gas (e.g., xenon) to photoionize the noble gas (e.g., PTL1).

Another known example is a lighting device that supports startup by detecting the lighting voltage and lighting an auxiliary light source when the lighting voltage exceeds a predetermined voltage (e.g., PTL2).

However, the portable communications device in PTL1 needs vacuum ultraviolet ray of at least 102 nm or below in order to photoionize the noble gas (xenon). To transmit the vacuum ultraviolet ray through the glass tube of the flash discharge tube, the glass tube needs to be formed of quartz glass. However, the quartz glass has high melting point and is difficult to process. It thus has disadvantages to be used for the glass tube of the flash discharge tube, such as its high cost and unsuitability for mass production.

The lighting device of PTL2 is for use only in dark places. It is further preferable if the lighting device determines whether or not to light the auxiliary light source depending on the surrounding environment, in addition to dark places. However, the above lighting device does not achieve it.

### CITATION LIST

### Patent Literature 1

Japanese Patent Unexamined Publication No. 2009-541787

Japanese Patent Unexamined Publication No. 2001-313189

### SUMMARY OF THE INVENTION

The present invention offers a stroboscopic device that stably emits light from a flash discharge tube irrespective of the light-emitting environment, and an image pickup device provided with this stroboscopic device.

More specifically, the stroboscopic device of the present invention includes a flash discharge tube having an anode and a cathode, and an auxiliary light emitter for emitting light toward the cathode. The auxiliary light emitter includes a light-receiving element for measuring a light intensity of external light near the flash discharge tube, a comparator for comparing the light intensity of the light received by the light-receiving element with a predetermined threshold immediately before or substantially simultaneously with the light emission from the flash discharge tube, and a lighting section that is lit when the light intensity is lower than the predetermined threshold based on a result of comparison by the comparator.

With this structure, the light-receiving element receives external light applied to the flash discharge tube immediately before or substantially simultaneously with the light emission from the flash discharge tube. When the light intensity of the light received by the light-receiving element is lower than the predetermined threshold, the lighting section is lit to apply light to the cathode. The light from the lighting section makes the cathode emit electrons in the flash discharge tube. As a result, the present invention achieves a low-cost flash discharge tube can stably emit light irrespective of the light-emitting environment.

The image pickup device of the present invention is provided with the above stroboscopic device. Accordingly, the present invention achieves a low-cost image pickup device that can stabilize light emission from the stroboscopic device.

### BRIEF DESCRIPTION OF DRAWINGS

FIG. 1 is a schematic view of a stroboscopic device in accordance with an exemplary embodiment of the present invention.

FIG. 2 is a flow chart for emitting light from a flash discharge tube in accordance with the exemplary embodiment.

FIG. 3 is a sectional view of a key part illustrating another example of a lighting section of the stroboscopic device in accordance with the exemplary embodiment.

FIG. 4 is a circuit diagram of an example of a circuit in a stroboscopic device.

### DESCRIPTION OF EMBODIMENT

An exemplary embodiment of the present invention is described below with reference to drawings. However, it is apparent that the scope of the present invention is not limited in any way by the exemplary embodiment.

### Exemplary Embodiment

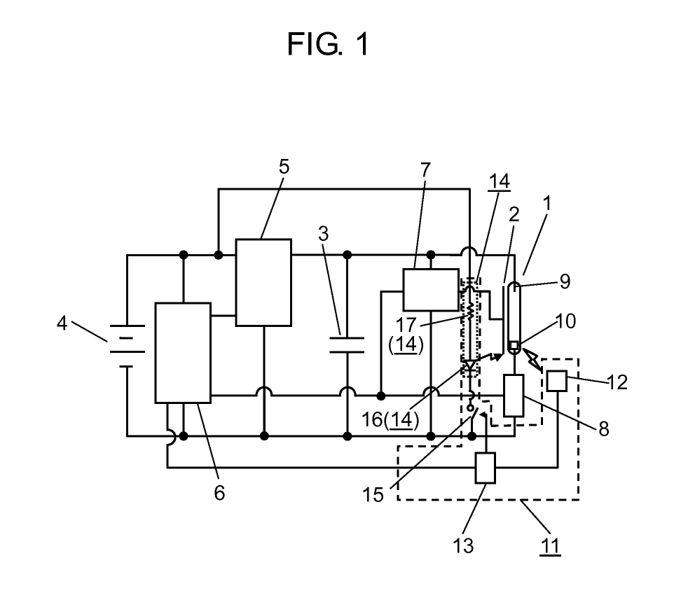

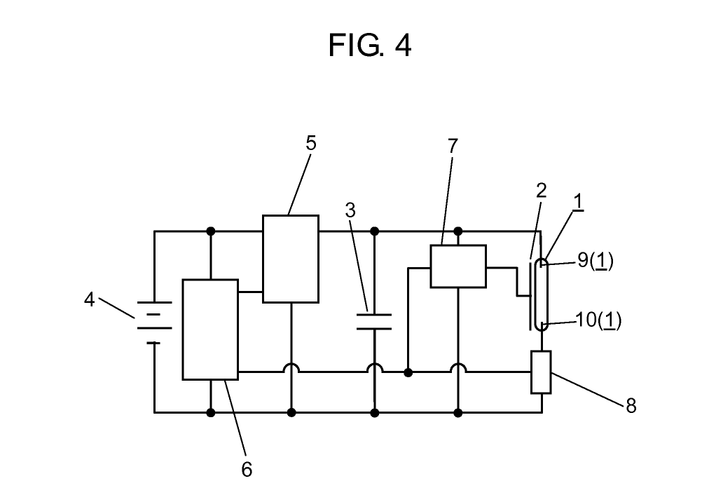

The stroboscopic device in the exemplary embodiment of the present invention is described below with reference to FIGS. 1 and 4. Same reference marks are given to parts same as that already described with reference to FIG. 4. Description of flash discharge tube 1, trigger external electrode 2, electric storage element 3, battery power source 4, boost chopper circuit 5, controller 6, trigger circuit 7, switch circuit 8, and anode 9 is omitted since they have the same configuration as that described previously with reference to FIG. 4.

FIG. 1 is a schematic view of the stroboscopic device in the exemplary embodiment of the present invention.

The stroboscopic device in the exemplary embodiment basically has a circuit configuration shown in FIG. 4.

The stroboscopic device in the exemplary embodiment includes auxiliary light emitter 11 for emitting light toward cathode 10 of flash discharge tube 1. The stroboscopic device is normally provided on an image pickup device to illuminate a shooting target as required.

Auxiliary light emitter 11 at least includes light-receiving element 12, comparator 13, lighting section 14, and switch 15. Light-receiving element 12 receives light applied to flash discharge tube 1 from outside. Comparator 13 compares the light intensity of the light received by light-receiving element 12 with a predetermined threshold immediately before or substantially simultaneously with the light-emission timing of flash discharge tube 1. Lighting section 14 is lit when the light intensity is lower than the predetermined threshold based on a result of comparison by comparator 13. Switch 15 turns on and off the lighting of lighting section 14.

In other words, light-receiving element 12 receives light reflected on flash discharge tube 1. More specifically, light-receiving element 12 receives a reflected light of the light applied to flash discharge tube 1 from outside. Therefore, light-receiving element 12 is preferably provided near flash discharge tube 1 in order to receive the light reflected on flash discharge tube 1.

Comparator 13 is connected to controller 6, light-receiving element 12, and switch 15.

The operation of comparator 13 is described in details below.

First, comparator 13 obtains from controller 6 timing that voltage is applied to trigger external electrode 2, i.e., timing to emit light from flash discharge tube 1. At the same time, comparator 13 obtains the light intensity of the light received by light-receiving element 12 immediately before or substantially simultaneously with the light-emission timing of flash discharge tube 1.

Next, comparator 13 compares the light intensity obtained with the predetermined threshold stored in advance. The predetermined threshold is, for example, about 100 lx that is darker than that of a fluorescent lamp.

When the light intensity obtained is lower than the predetermined threshold, comparator 13 sends a signal to turn on switch 15. This makes lighting section 14 connected to battery power source 4. Conversely, when the light intensity obtained is higher than the predetermined threshold, comparator 13 sends a signal to turn off switch 15. This makes lighting section 14 disconnected from battery power source 4.

Comparator 13 operates as described above.

Lighting section 14 is configured with light-emitting diode 16 and resistance 17. Lighting section 14 is connected to the positive electrode side of battery power source 4, and also to switch 15. Here, when switch 15 is turned on based on the signal from comparator 13, light-emitting diode 16 of lighting section 14 is lit to apply light to cathode 10 of flash discharge tube 1.

Lighting section 14 preferably applies, for example, white light or ultraviolet light emitted from light-emitting diode to cathode 10. More specifically, light-emitting diode 16 of lighting section 14 preferably emits light including a wavelength from 350 nm to 650 nm to cathode 10. Therefore, light-emitting diode 16 of lighting section 14 is, for example, a white LED configured with a blue LED typically with a wavelength of 470 nm (InGaN chip) and a resin package in which yellow phosphor or green and red phosphor with improved color rendering are mixed. A white light is applied from the white LED to cathode 10. This enables to easily emit electrons from cathode 10, as described later.

In the same way, switch 15 is connected to the negative electrode side of battery power source 4 and also to lighting section 14. Switch 15 is further connected to comparator 13 to receive an ON or OFF signal from comparator 13. More specifically, when switch 15 receives the ON signal from comparator 13, a circuit between lighting section 14 and the negative electrode side of battery power source 4 is closed to establish an ON state of lighting section 14. Conversely, when switch 15 receives the OFF signal from comparator 13, the circuit between lighting section 14 and the negative electrode side of battery power source 4 is opened to establish an OFF state of lighting section 14. In this way, ON and OFF of light emission from light-emitting diode 16 of lighting section 14 is controlled.

A structure of cathode 10 in the exemplary embodiment is described in details below.

First, cathode 10 is formed of a substance with low work function, such as cesium or a compound at least containing cesium. This makes cathode 10 generate the photoelectric effect by light applied from lighting section 14 or outside. By this photoelectric effect, cathode 10 emits electrons inside flash discharge tube 1. An action of the photoelectric effect is described below.

The photoelectric effect is described in details, taking an example that cathode 10 is formed of cesium.

When cathode 10 receives light with a wavelength of 650 nm or below from light-emitting diode 16 of lighting section 14, surplus energy exceeding the work function of 1.93 eV is emitted in the form of electrons inside flash discharge tube 1 by the photoelectric effect. This enables to apply low voltage between anode 9 and cathode 10 of flash discharge tube 1.

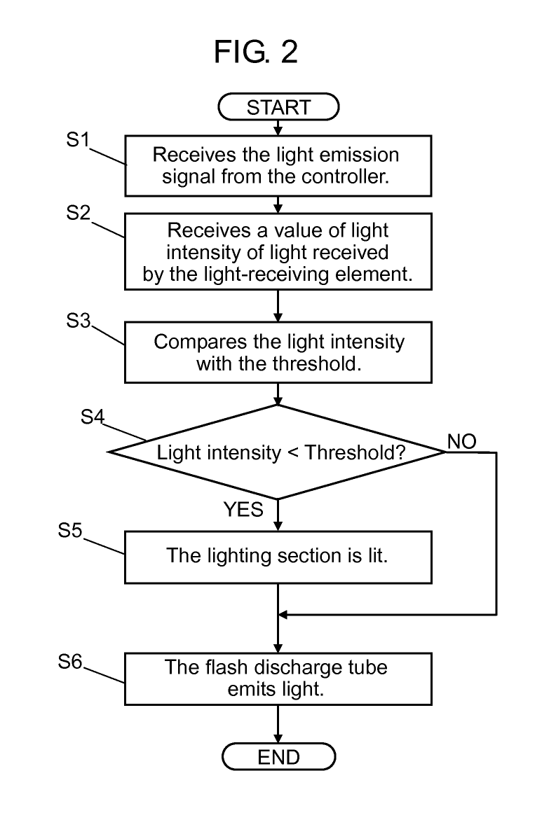

Next, the operation of light emission from flash discharge tube 1 in the stroboscopic device and image pickup device in the exemplary embodiment is described using FIG. 2 and with reference to FIG. 1. More specifically, a flow until flash discharge tube 1 emits light, using auxiliary light emitter 11, is described.

FIG. 2 is a flow chart of light emission from the flash discharge tube in the exemplary embodiment.

As shown in FIG. 2, comparator 13 of auxiliary light emitter 11 receives a light emission signal from controller 6 (Step S1).

Next, comparator 13 receives a signal from controller 6 immediately before or substantially simultaneously with light emission and obtains a light intensity of external light received by light-receiving element 12 of auxiliary light emitter 11 (Step S2).

Then, comparator 13 compares the light intensity of the light obtained with the predetermined threshold stored in advance (Step S3).

Next, comparator 13 determines whether or not the light intensity obtained is smaller than the predetermined threshold (Step S4). When comparator 13 determines that the light intensity obtained is smaller than the predetermined threshold (YES in Step S4), comparator 13 sends a signal to turn on switch 15 to switch 15 of auxiliary light emitter 11. Based on the ON signal received from comparator 13, switch 15 closes the circuit between the negative electrode side of battery power source 4 and lighting section 14. In other words, switch 15 closes the circuit between the negative electrode side of battery power source 4 and lighting section 14 to light light-emitting diode 16 of lighting section 14 on receiving the ON signal from comparator 13 (Step S5). Cathode 10 is thus exposed to light from lighting section 14 and generates the photoelectric effect to emit electrons inside flash discharge tube 1.

Electrons emitted from cathode 10 are accelerated by an electric field applied between anode 9 and cathode 10.

By ionizing the noble gas (xenon) with accelerated electrons, flash discharge tube 1 emits light (Step S6).

Conversely, when comparator 13 determines that the light intensity obtained is higher than the predetermined threshold, (NO in Step S4), comparator 13 sends a signal to turn off switch 15 to switch 15.

The noble gas (xenon) is ionized by voltage applied between anode 9 and cathode 10 of flash discharge tube 1. This enables to emit light from flash discharge tube 1 (Step S6). In this case, flash discharge tube 1 emits light without ionizing the noble gas (xenon) with accelerated electrons.

As described above, in the stroboscopic device and image pick up device in the exemplary embodiment, comparator 13 of auxiliary light emitter 11 first compares the light intensity of the light obtained from light-receiving element 12 with the predetermined threshold based on timing obtained from controller 6 immediately before or substantially simultaneously with the light emission.

When the light intensity obtained from light-receiving element 12 is lower than the predetermined threshold, comparator 13 makes light-emitting diode 16 of lighting section 14 emit light.

Then, the noble gas (xenon) is ionized by the sum of electron energy emitted in flash discharge tube 1 by light emission from lighting section 14 and energy given to the noble gas (xenon) from trigger external electrode 2. This enables to emit light while reducing the lighting voltage of flash discharge tube 1. As a result, stability of light emission of flash discharge tube 1 can be increased.

Conversely, when the light intensity of the light obtained from light-receiving element 12 is higher than the predetermined threshold, comparator 13 does not make light-emitting diode 16 of lighting section 14 emit light. This enables to suppress power consumption for lighting light-emitting diode 16 of lighting section 14, and can also increase the stability of light emission from flash discharge tube 1. In other words, cathode 10 is activated by applying external light to cathode 10 of flash discharge tube 1. Then, free electrons are emitted inside flash discharge tube 1 from cathode 10 to facilitate light emission. Accordingly, stability of light emission increases.

In the exemplary embodiment, light is applied to cathode 10 by the light emission from light-emitting diode 16 of lighting section 14. This enables to reduce cost compared to the case of photoionizing the noble gas (xenon) in flash discharge tube 1 by directly applying voltage between anode 9 and cathode 10. More specifically, cost can be reduced by typically eliminating the voltage doubler circuit.

The stroboscopic device and image pickup device in the exemplary embodiment are not limited to the above exemplary embodiment. It is apparent that any modifications within the spirit of the present invention are applicable.

For example, the above exemplary embodiment refers to light-receiving element 12 provided near the side of cathode 10 of flash discharge tube 1. However, light-receiving element 12 is not limited to this position. More specifically, the light-receiving element may be provided inside flash discharge tube 1 together with cathode 10. This enables to appropriately receive light applied to cathode 10. Still more, light-receiving element 12 may not be provided near flash discharge tube 1, so as to receive the light intensity of light in the surrounding environment of flash discharge tube 1. This reduces limitation in the component layout, and thus increases design flexibility.

Still more, the above exemplary embodiment refers to light-receiving element 12 that receives the light intensity of external light of flash discharge tube 1. However, the present invention is not limited to this configuration. For example, the light-receiving element may be a light-receiving element that receives light emitted from flash discharge tube 1 for measuring the light emission intensity of light emitted from flash discharge tube 1. Still more, light-receiving element 12 may also function as an image pickup element (not illustrated) of the image pickup device. This has an effect of reducing cost by decreasing the number of components.

Still more, the exemplary embodiment refers to an example of configuration that emits the white light as light-emitting diode 16 of lighting section 14. However, the present invention is not limited to the white light. For example, lighting section 14 is further preferably configured to emit light including the blue light. This enables to give sufficient energy to cathode 10. As a result, the photoelectric effect encourages the emission of sufficient electrons inside flash discharge tube 1 from cathode 10 to further decrease the lighting voltage.

Still more, the exemplary embodiment refers to an example of providing comparator 13 in auxiliary light emitter 11. However, the present invention is not limited to this structure. For example, comparator 13 may be provided in controller 6. In this case, controller 6 may be provided with a function of comparator 13 by its internal arithmetic processing unit. This has an effect of achieving low cost by reducing the number of components.

Still more, the exemplary embodiment refers to an example of white LED configured with the blue LED and a resin package in which yellow phosphor or green and red phosphors with improved color rendering are mixed. However, the present invention is not limited to this configuration. For example, light-emitting diode 16 of lighting section 14 may be white LED configured with the ultraviolet LED and a resin package in which red, blue, and green phosphors are mixed to obtain the same effect.

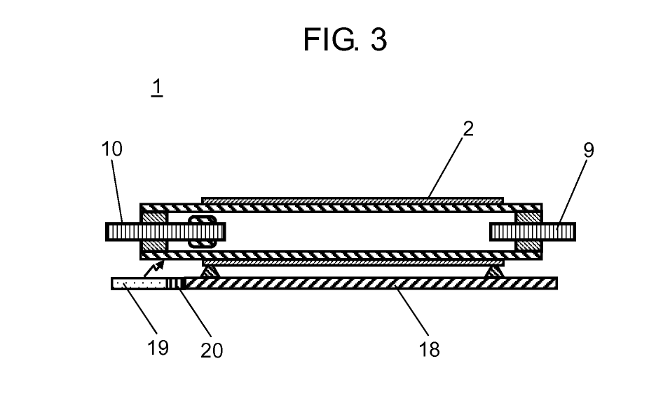

Still more, the exemplary embodiment refers to an example of configuring lighting section 14 with white LED. However, the present invention is not limited to this structure. For example, as shown in FIG. 3, the lighting section may be formed of a self light-emitting element 19, such as organic EL. In this case, for example, a part of reflector 18 also functioning as trigger external electrode 2, is insulated by insulator 20 and self light-emitting element 19 is formed by deposition or application at a portion facing cathode 10. This can reduce a volume needed for auxiliary light emitter 11. As a result, a smaller stroboscopic device can be achieved.

Furthermore, in the exemplary embodiment, a light source with a wavelength of 650 nm or below may be combined when the cathode material is cesium and the glass tube of the flash discharge tube is fused quartz (quartz glass). In addition, a light source with a wavelength from 350 nm to 650 nm may be combined when the cathode material is cesium and the glass tube of the flash discharge tube is hard glass. When the cathode material is a material other than cesium and the glass tube of the flash discharge tube is fused quartz or existing glass, the cathode material is preferably formed of a material with work function that satisfies Table 1 below. This achieves the same effect as the exemplary embodiment.

TABLE 1

| | Work function (eV) | | | |
|---|---|---|---|---|
| | Quartz glass | | Existing glass | |
| Infrared light source | 1.5 | eV and over | 1.5 | eV and over |
| 800 nm and over | | | | |
| White LED | 1.9~2.9 | eV | 1.9~2.9 | eV |
| 460~650 nm | | | | |
| UV light source | 3.45 | eV and over | 3.45~4.13 | eV |
| 350 nm and below | | | | |

As described above, the stroboscopic device of the present invention includes the tubular flash discharge tube having the anode and cathode inside its both ends, and the auxiliary light emitter for emitting light toward the cathode. The auxiliary light emitter may include the light-receiving element for measuring the light intensity of external light near the flash discharge tube, the comparator for comparing the light intensity of the light received by the light-receiving element with the predetermined threshold immediately before or substantially simultaneously with the light-emission timing of from the flash discharge tube, and the lighting section that is lit when the light intensity is lower than the threshold based on a result of comparison by the comparator.

With this structure, the light-receiving element enables to receive the light applied from outside to the flash discharge tube immediately before or substantially simultaneously with the light-emission timing of the flash discharge tube. When the light intensity of the light received by the light-receiving element is lower than the predetermined threshold, the lighting section is lit to apply light to the cathode. This makes the cathode emit electrons inside the flash discharge tube. Accordingly, light emission from the flash discharge tube can be stabilized at low cost irrespective of the light-emitting environment.

Still more, in the stroboscopic device of the present invention, the light-receiving element may measure the light intensity of external light near the cathode. This enables to appropriately determine the light intensity of the light received by the cathode, and thus whether or not to light the lighting section can be appropriately determined.

Still more, in the stroboscopic device of the present invention, the light-receiving element may measure the light emission intensity of light emitted from the flash discharge tube. This enables to use the light-receiving element for measuring the light emission intensity of the flash discharge tube also as a light-receiving element for receiving light applied from outside to the flash discharge tube, achieving low cost.

Still more, in the stroboscopic device of the present invention, the lighting section may emit white or ultraviolet light.

Still more, in the stroboscopic device of the present invention, the lighting section may emit light including a wavelength from 350 nm to 650 nm.

Still more, in the stroboscopic device of the present invention, the cathode may be formed of a substance at least containing cesium.

The above configurations give sufficient energy to the cathode for emitting electrons, and thus light emission from the flash discharge tube can be stabilized. In addition, the lighting section emitting light with the above wavelength enables to effectively prevent reflection of light leaked from the lighting section on a shooting target.

Furthermore, in the stroboscopic device of the present invention, the lighting section may be formed of a self light-emitting element disposed near the cathode.

The self light-emitting element is provided, as a light source of the lighting section, by electrically insulating a part of the reflector umbrella and applying the self light-emitting element to a portion facing near the cathode. This can reduce the volume needed for the auxiliary light emitter. As a result, a smaller stroboscopic device can be achieved.

Still furthermore, the image pickup device of the present invention may be equipped with the above stroboscopic device. This achieves the image pickup device with stable light emission at low cost.

### INDUSTRIAL APPLICABILITY

The present invention is effectively applicable to stroboscopic devices that require stable light emission depending on light-emitting environments, such as a dark place, and image pickup devices equipped with the stroboscopic device.

### REFERENCE MARKS IN THE DRAWINGS

1 Flash discharge tube
2 Trigger external electrode
3 Electric storage element
4 Battery power source
5 Boost chopper circuit
6 Controller
7 Trigger circuit
8 Switch circuit
9 Anode
10 Cathode
11 Auxiliary light emitter
12 Light-receiving element
13 Comparator
14 Lighting section
15 Switch
16 Light-emitting diode
17 Resistance
18 Reflector
19 Self light-emitting element
20 Insulator

1. A stroboscopic device comprising:
a flash discharge tube having an anode and a cathode; and
an auxiliary light emitter for emitting light toward the cathode, the auxiliary light emitter comprising:
a light-receiving element for measuring a light intensity of external light near the flash discharge tube;
a comparator for comparing the light intensity of light received by the light-receiving element with a predetermined threshold at one of timings of immediately before and substantially simultaneously with light emission from the flash discharge tube; and
a lighting section that is lit when the light intensity is lower than the predetermined threshold based on a result of comparison by the comparator.

2. The stroboscopic device of claim 1,
wherein
the light-receiving element measures the light intensity of the external light near the cathode.

3. The stroboscopic device of claim 1,
wherein
the light-receiving element measures a light emission intensity of light emitted from the flash discharge tube.

4. The stroboscopic device of claim 1,
wherein
the lighting section emits one of white light and ultraviolet light including a wavelength from 350 nm to 650 nm.

5. The stroboscopic device of claim 1,
wherein
the cathode is formed of a substance at least containing cesium.

6. The stroboscopic device of claim 1,
wherein
the lighting section is formed of a self light-emitting element disposed near the cathode.

7. An image pickup device provided with the stroboscopic device of claim 1.
